(19) United States
(12) Patent Application Publication
(10) Pub. No.: US 2005/0038874 A1
(43) Pub. Date: Feb. 17, 2005

(54) System and method for downloading data using a proxy

(76) Inventors: Kumar Ramaswamy, Princeton, NJ (US); Jun Li, Plainsboro, NJ (US)

Correspondence Address: THOMSON MULTIMEDIA LICENSING INC;JOSEPH S TRIPOLI, PO BOX 5312, 2 INDEPENDENCE WAY, PRINCETON, NJ, 08543-5312, US

(21) Appl. No.: 10/498,329

(22) PCT Filed: Dec. 10, 2002
(86) PCT No.: PCT/US02/39475

Related U.S. Application Data
(60) Provisional application No. 60/340,661, filed on Dec. 13, 2001.

(51) Int. Cl. G06F 15/16

(52) U.S. Cl. 709/219; 709/217

(57) ABSTRACT

A Content Request System (CRS) is operated to request the downloading of content from a Content Server to a Content Viewing System using a proxy and an Intermediary Server. CRS obtains parameters related to the download including at least an identification of data to be downloaded, the identity of a CS containing the identified data, and the identity of an IS to which the identified data is to be downloaded. CRS creates a proxy that facilitates the downloading of the identified data from the identified CS, the proxy containing the obtained parameters. The proxy is transmitted to the identified IS which uses the proxy to download the identified data from the identified CS in accordance with the parameters contained in the proxy. The identified IS then transfers the downloaded data to CVS.

### CROSS-REFERENCE TO RELATED APPLICATIONS

This application claims priority from U.S. Provisional Application No. 60/340,661, filed on Dec. 13, 2001, which is hereby incorporated by reference into this application.

### FIELD OF THE INVENTION

The invention disclosed herein relates to a system and method for transferring data across a data communications network.

### BACKGROUND OF THE INVENTION

Conventionally, when a user operates a client device to send a request to a content server to download content, the content server proceeds to immediately download the requested content to the client device that sent the request. However, this immediate fulfillment of a download request may be undesirable in situations where the client device sending the request lacks the processing capability to use the requested content, e.g., a mobile device requesting a video file, or where the communications network linking the client device and the content server lacks sufficient bandwidth at the time of the request to transfer the requested content in a timely manner, e.g., a cellular network with limited bandwidth linking a mobile device to the content server or a network experiencing congestion at the time of the request.

U.S. Pat. No. 5,987,504 to Toga describes a method and apparatus for delivering data in which a client sends a request message to a server according to a first protocol (e.g., HTTP) identifying a data file and a storage location, such as an e-mail address. In response, the server forwards the requested data file to the e-mail address according to a second protocol (e.g., SMTP). The requested data file can be retrieved by a second client at a later time.

### SUMMARY OF THE INVENTION

The present invention provides for data to be downloaded from servers to client devices using proxies that enable the download to occur to a different location other than the client device making the download request or to occur at a different time other than when the client device generates the download request. A user operates a client device to request the downloading of content. Rather than communicate directly with a server containing the desired content to request the download, the client device generates a proxy containing parameters describing the desired download and transmits the proxy to an computer at the desired location which uses the proxy to download the desired content at the desired time. The content resides at the computer until retrieved by the user.

Thus, the present invention provides for various improved downloading capabilities. Where a user has a limited client device incapable of viewing desired content, the user may operate the device to generate and transmit a proxy to a computer that downloads and stores the content until the user can retrieve the content and view it with a more capable client device.

Also, where a user currently communicates with a content server through a high delay or low bandwidth network that cannot download the desired content in a timely manner, the user may operate his or her client device to generate and transmit a proxy to a computer to which the user has access through a low delay or high bandwidth network. After the desired content is downloaded to the computer, the user may connect with the computer through the low delay, high bandwidth network to speedily retrieve the downloaded content.

Also, the user may utilize the present invention to download content to locations that the user will arrive at in the future. For example, a traveler may use a client device to generate and transmit proxies to computers accessible at hotels or transport hubs, e.g., airports, where the traveler expects to arrive at during his or her travels. As the traveler arrives at each location, he or she accesses the computer at the location to which the content was downloaded to retrieve the content.

The invention provides a method, system, and computer program product for facilitating the transfer of data from at least one server to a client device. Parameters are provided including at least the identity of the data to be downloaded and the identity of the at least one server to a previously identified computer from which the data can be transferred to the client device. Then, the previously identified computer uses the parameters to cause the data to be transferred from the at least one server to the computer.

According to an embodiment of the invention, a proxy is created that facilitates the downloading of data from the at least one server. The proxy is then transmitted to a computer capable of using the proxy to download the data from the at least one server and then transferring the downloaded data to the client device.

According to another embodiment of the invention, a proxy is received containing parameters including at least an identification of the data to be downloaded and the identity of the at least one server. The proxy is used to download the identified data from the identified at least one server. Then, the downloaded data is transferred to the client device.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram showing an embodiment of the present invention and the environment in which it operates;

FIG. 2 is a block diagram showing another embodiment of the invention;

FIG. 3 is a flowchart showing an operative embodiment of the invention; and

FIG. 4 is a flowchart showing another operative embodiment of the invention.

### DETAILED DESCRIPTION

Preferred embodiments of a method, system, and article of manufacture containing software programs in accordance with the present invention are described with reference to the drawings.

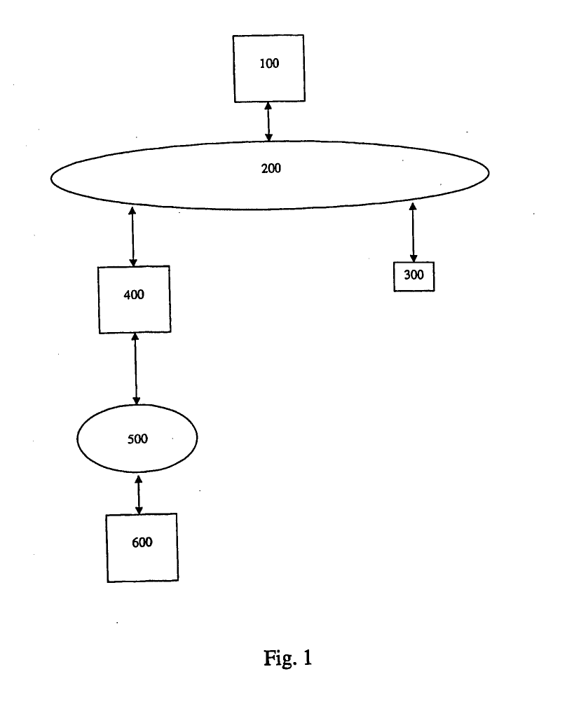

As shown in FIG. 1, a Content Server 100 communicates with other computer systems through a First Network 200. A user operates a Content Request (“CR”) System 300 to request the downloading of content from Content Server 100. To effect a download, CR System 300 generates and sends a proxy through First Network 200 to an Intermediary Server 400 which operates with this proxy to cause the requested content to be downloaded from Content Server 100 to the Intermediary Server 400. The user then operates a Content Viewing (“CV”) System 600 to communicate with Intermediary Server 400 through a Second Network 500 to retrieve the downloaded content from Intermediary Server 400 to CV System 600 where the content can be viewed.

Content Server 100 stores content that can be downloaded to users and may comprise any computer system capable of storing digital content and interacting with other computer systems through a communication network so as to facilitate the transferring of the stored content to the other computer systems through the communication network. For example, Content Server 100 may comprise a web server that communicates with client computers and transfers stored video files to client computers. Although Content Server 100 is shown in FIG. 1 as a single entity, it should be understood that content server 100 may comprise a number of computer systems. For example, Content Server 100 may comprise a video server farm in communication with a web server front end.

First Network 200 is in communication with Content Server 100 and provides a pathway through which Content Server 100 can communicate with other computer systems and communication networks. First Network 200 may comprise any communication network through which computers can communicate with each other, such as, for example, a LAN, a WAN, a public switched telephone network, a cellular network, or the Internet. Also, although First Network 200 is shown in FIG. 1 as a single network, it should be understood that First Network 200 may comprise a plurality of networks in communication with each other.

Content Request (“CR”) System 300 is operated by a user to request content from Content Server 100. CR System 300 does not communicate directly with content servers to request content. Rather, as mentioned above and described further below, CR System 300 generates and sends proxies to an Intermediary Server 400 which operates with these proxies to effect the downloading of the desired content. As described below, a proxy is means in a broad sense and encompasses (a) data that enables a computer to download content on behalf of a user, or (b) data and computer code that processes the data to download content on behalf of a user. Thus, CR System 300 may comprise any computer system capable of generating proxies, as described below, and transferring these proxies to another computer system, e.g., an Intermediary Server 400, through a network.

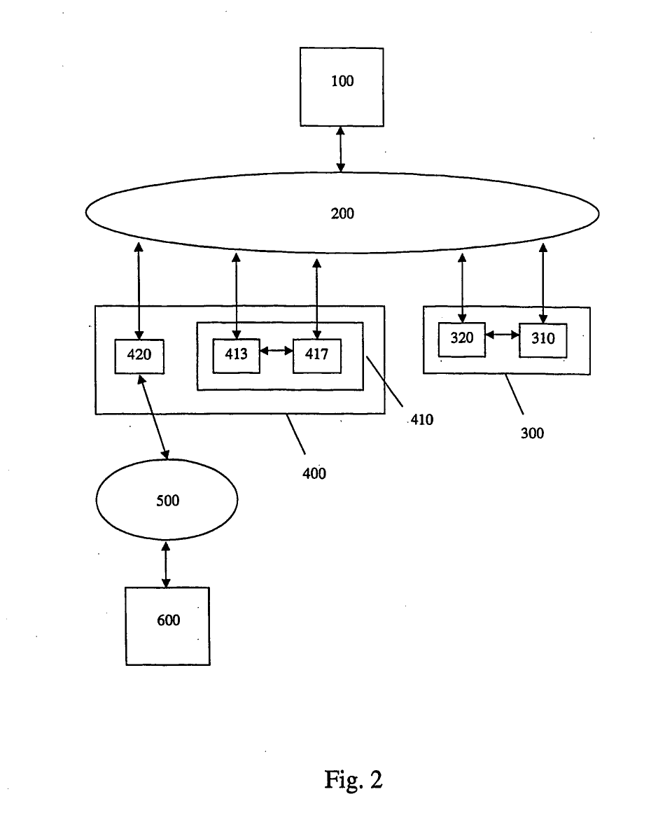

In an embodiment of the invention shown in FIG. 2, CR System 300 comprises a computer system typically used as a client device (e.g., a PC, notebook computer, PDA, or advanced cell phone) having a Proxy Generator (“PG”) System 310 enabling it to generate proxies, as described below. For example, PG System 310 may comprise computer code designed to perform this function.

In an embodiment of the invention, a proxy comprises data that enables an Intermediary Server 400 to act on behalf of a user to download content from a content server. This data may include, for example, (a) identity information of the content to be downloaded, (a) user information required to access the content, and (c) information regarding how the download is to be performed. Content identity information may include, for example, the filename and network address of the content to be downloaded including the network address of the content server on which the content resides. The user information required to access the content may include any information necessary to gain access to the content to be downloaded as well as the content server on which the content resides, including, for example, user ID and password information. Where the content must be paid for, user information may also include payment related information, such as, for example, authentication and account information. Information regarding how the download is to be performed may include, for example, a time at which the download is to occur or a location to which the content is to be downloaded, e.g., the network address of an Intermediary Server 500.

In another embodiment of the invention, the proxy comprises data and computer code. The data, as described above, enables a computer system to act on behalf of a user to download content from a content server (e.g., includes content identity information, user information, and information regarding the download). The computer code provides the functionality of requesting the downloading of content from a content server. Thus, a computer system executing the computer code contained in the proxy acts to request the downloading of content based on the data contained in the proxy. For example, where the content server is an HTTP server the proxy may contain computer code enabling a computer system to function as an HTTP client.

Although the data contained in a proxy may be predefined and static, CR System 300 may contain components enabling this data to be dynamically provided. For instance, CR System 300 may include a user interface that allows a user to provide any of the aforementioned types of data and a storage for storing the provided data and from which the provided data can be later retrieved.

For example, a user may use the user interface to provide a desired date and time at which the requested download is to occur. In another example, a user may use the user interface to input download destination locations (e.g., network addresses of Intermediary Servers 400 to which content may be downloaded and from which downloaded content may be retrieved) which may be used immediately to generate a proxy or may be stored in the storage and retrieved later through the user interface to generate a proxy. In this manner, information may be stored and later retrieved regarding locations a user frequently downloads to, e.g., Intermediary Servers 400 associated with the user's home or office. Also, information may be stored and later retrieved regarding locations a user expects to travel to, e.g., Intermediary Servers 400 associated with airports the user expects to travel through or hotels at which the user expects to stay.

In a preferred embodiment of the invention, CR System 300 contains a Content Server Communication System (“CSC”) System 320, as shown in FIG. 2, that enables CR System 300 to communicate with a content server in order to obtain content identity information. In this embodiment, a user operates the CSC System 320 to communicate with a content server to determine what content is available for download from the server. The user selects the content to be downloaded and the selection is sent to PG System 310 which extracts the content identity information from the selection. For example, where the content server to be accessed is a web server, CSC System 320 may comprise a standard web browser that is modified by known methods, e.g., a plug-in, so that download requests normally sent to the web server are redirected to PG System 310. A user operates the web browser to interact with the web server and identify content available for download. When the user selects the content to download (e.g., by selecting a link to the desired content presented by the web server), the download request created by the web browser that is normally sent to the web server is instead redirected to PG System 310 which extracts content identity information (e.g., the filename of the content and the IP address of the web server) from the request.

Returning to FIG. 1, an Intermediary Server 400 is shown in communication with Content Server 100 and CR System 300 through First Network 200 and is shown in communication with a CV System 600 through Second Network 500. Intermediary Server 400 may comprise any computer system capable of (a) receiving proxies and operating with those proxies to cause content files to be downloaded to it from a content server, and (b) receiving and storing content files from content servers and transferring the stored content files to other computer systems.

In an embodiment of the invention, shown in FIG. 2, Intermediary Server 400 comprises a Proxy Host (“PH”) System 410 and a File Server (“FS”) System 420. PH System 410 receives proxies and operates with those proxies to cause content files to be downloaded from a content server to FS System 420. PH System 410 may comprise a Storage 413, which stores proxies received from one or more CR Systems 300, and a Scheduler 417, which causes each proxy stored in Storage 413 to be executed at the time indicated by the data contained in the respective proxy. PH System 410 may comprise computer code performing the functionality of Storage 413 and Scheduler 417.

For example, where the stored proxies comprise data, then Scheduler 417 may comprise computer code that functions to create a client capable of communicating with the content server that is the subject of the proxy in order to request that content be downloaded to Storage 413 according to the data contained in the proxy. For instance, where the content server containing the content desired to be downloaded is an HTTP server, Scheduler 417 may comprise computer code that generates an HTTP client that communicates with the HTTP server to download content according to the data contained in the proxy.

In another example, where the proxies received from CR Systems 300 and stored in Storage 413 comprise computer code as well as data, Scheduler 417 may comprise computer code enabling it to execute the computer code contained in the proxies. For instance, where a stored proxy contains computer code for an HTTP client, Scheduler 417 executes the proxy to generate an HTTP client, and where a proxy contains computer code for an FIP client, Scheduler 417 executes the proxy to generate an FTP client.

FS System 420 receives and stores content files from content servers for later retrieval by end users. FS System 420 may comprise a plurality of individual storage areas, each corresponding to a different end user. FS system 420 may also comprise any known means for providing access to its stored files, such as, for example, a user interface. In addition, FS System 420 may comprise known means for controlling access, including security measures, e.g., user ID and password.

Second Network 500 provides a pathway through which Intermediary Server 400 can communicate with CV System 600. Second Network 500 may comprise any communication network through which computers can communicate with each other. In a preferred embodiment, comprises a low delay, large bandwidth network, such as, for example, a WLAN or a digital cable network. Also, although Second Network 500 is shown in FIGS. 1 and 2 as a single network, it should be understood that Second Network 500 may comprise a plurality of networks in communication with each other.

CV System 600 may comprise any computer system capable of receiving digital content through a network and presenting that content to a user. For example, CV System 600 may comprise a computer system typically used as a client device for viewing digital content (e.g., a PC, notebook computer, PDA, or advanced cell phone).

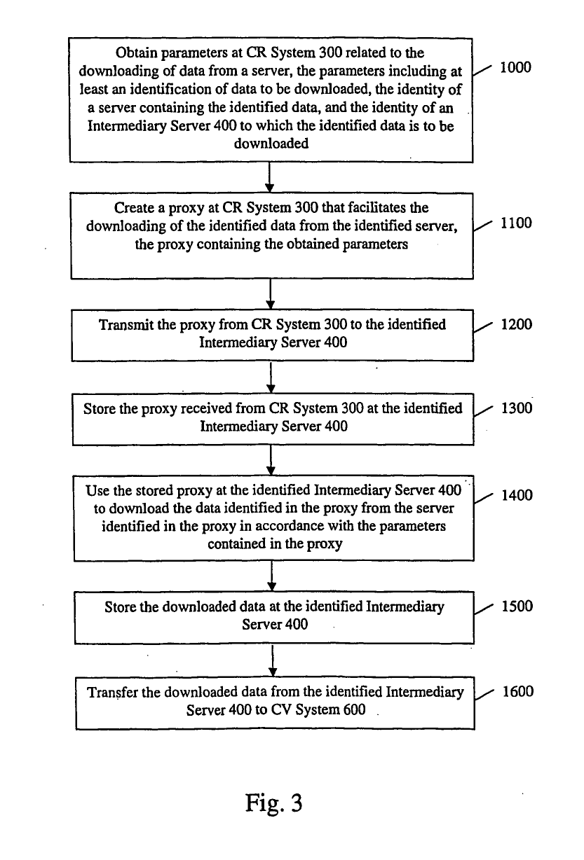

FIG. 3 is a flowchart showing one way in which the present invention may operate. First, as represented in block 1000, CR System 300 obtains parameters related to the downloading of data from a server, the parameters including at least an identification of data to be downloaded, the identity of a server containing the identified data, and the identity of an Intermediary Server 400 to which the identified data is to be downloaded. The identification of data to be downloaded may include, for example, the filename and network address of content to be downloaded. The identity of a server containing the identified data may include, for example, the network address of a server acting as a Content Server 100, as described above, on which the identified content resides. The identity of an Intermediary Server 400 to which the identified data is to be downloaded may include, for example, the network address of a computer system acting as an Intermediary Server 500, as described above.

CR System 300 may also obtain other parameters at this time. These other parameters may include, for example, user information required to access the content (e.g., user ID and password, and payment information, such as authentication and account information) and a time, which may include a date, at which the download is to occur.

CR System 300 may obtain these parameters in a number of ways. For example, some of these parameters may be static and predefined. For instance, the identity of the server containing the identified data or the identity of the Intermediary Server 400 may be predefined where content is always downloaded from the same content server or where content is always downloaded to the same Intermediary Server 400, respectively.

Alternatively, CR System 300 may obtain some or all of these parameters from a user through a user interface. For example, a user may use the user interface to provide a desired time at which the requested download is to occur. Also, parameters provided by a user may be stored in a storage and retrieved later by a user through the user interface. For example, a user may use the user interface to retrieve the identity of one Intermediary Server 400 from several that have been previously provided and stored.

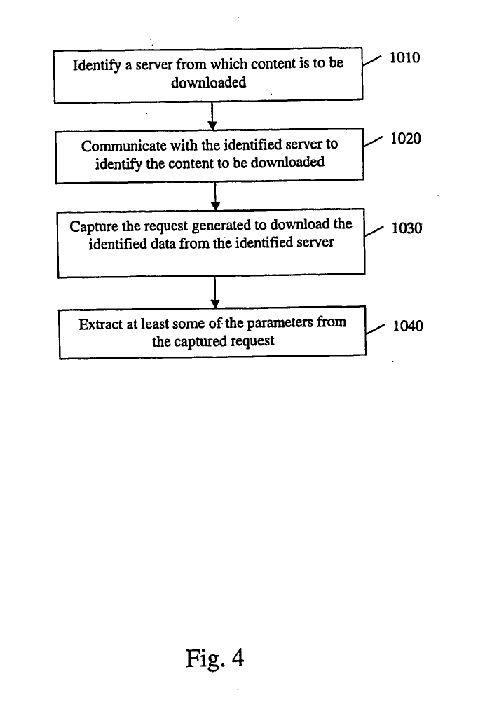

In an embodiment of the invention, CR System 300 obtains at least some of these parameters using a data communication device, such as, for example, the CSC System 320 described above. FIG. 4 is a flowchart showing one technique for obtaining at least an identification of data to be downloaded and the identity of a server containing the identified data where the CSC System 320 comprises a web browser modified as described above. First, as represented in block 1010, a server is identified from which content is to be downloaded. This may be accomplished by, for example, a user operating the web browser to identify a web site corresponding to a Content Server 100 having the type of content that the user wishes to download.

Next, this identified server is communicated with to identify the content to be downloaded, as represented in block 1020. For example, the user may operate the web browser to navigate the web site until the user identifies content that he or she wishes to download by selecting on a link associated with the desired content.

Next, the request generated to download the identified data from the identified server is captured, as represented in block 1030. For example, in response to a user selecting content to be downloaded, a standard web browser generates a request to the server to download the selected content. Such a request typically includes the identity of the server (e.g., the server's network address) from which data is to be downloaded as well as the identity of the content to be downloaded (e.g., the content's filename and network address). As described above, the web browser in the present invention is modified to redirect this generated request so that it is captured by the PG System 310 of CR System 300.

Finally, as represented in block 1040, at least some of the parameters are extracted from the captured request. For example, PG System 310 may extract the identification of the data to be downloaded (e.g., filename and network address) and the identity of the server containing the identified data (e.g., network address) from the captured request.

It should be noted that in the embodiment of the invention shown in FIG. 4, if no parameters are obtained from the user, e.g., through a user interface, then the process of obtaining parameters, as represented in block 1000, and the operations involved in creating an object and transmitting the object to an Intermediary Server 400, represented in blocks 1100 and 1200, respectively, described further below, appear transparent to the user.

Returning to FIG. 3, after parameters are obtained, proxy is created that facilitates the downloading of the identified data from the identified server, where the proxy contains the obtained parameters, as represented in block 1100. For example, PG System 310 of CR System 300 may create a proxy, as described above, comprising either a data or data and computer code, which another computer can use to download the identified data from the identified server. CR System 300 then transmits this proxy to the Intermediary Server 400 identified in the obtained parameters, as represented in block 1200.

After receiving the object from CR System 300, Intermediary Server 400 stores the received proxy, as represented in block 1300. For example, Intermediary Server 400 may store the received proxy in Storage 413 of PH System 410. Then, as represented in block 1400, Intermediary Server 400 uses the stored proxy to download the identified data from the identified server in accordance with the parameters contained in the proxy.

The operations represented in block 1400 may be accomplished by, for example, Scheduler 417 of PH System 410 using the stored proxy to download the identified data from the identified server at the time indicated by the parameters contained in the proxy in accordance with the parameters contained in the proxy. For example, in an embodiment of the invention, as described previously, where the received proxy comprises data, Scheduler 417 may accomplish the operations represented in block 1400 by creating and executing, at the time indicated in the parameters of the proxy, a client capable of communicating with the server identified by the parameters of the proxy in order to request that the data identified by the parameters of the proxy be downloaded to the FS System 420 of the Intermediary Server 400 executing the client. The client then communicates with the server identified by the parameters of the proxy to download the identified data from the identified server according to the parameters of the object, for example, using the user information, e.g., user ID and password and payment information, contained in the proxy. It should be noted that where the parameters of the proxy do not indicate a time, a predetermined date and time may be used, e.g., immediately.

In another embodiment of the invention, as described previously, where the received proxy comprises a data as well as computer code, Scheduler 417 may accomplish the operations represented in block 1400 by executing, at the time indicated in the parameters of the proxy, the computer code contained in the proxy. This causes a client to be created that communicates with the identified server to download the identified data to the FS System 420 of the Intermediary Server 400 hosting the client according to the parameters of the proxy, for example, using the user information contained in the proxy as described above.

It should be noted that an Intermediary Server 400 may receive a plurality of proxies from a plurality of CR Systems 300. Each received proxy may be stored and organized in Storage 413, e.g. as in a queue, so that each stored proxy may be used to perform the download represented by the proxy's parameters at the time indicated by the proxy's parameters.

Returning to FIG. 3, after the stored proxy is used to download the identified data, Intermediary Server 400 stores the downloaded data, as represented in block 1500. For example, Intermediary Server 400 may store the downloaded data in one of a plurality of storage areas in FS System 420 according to the user information of the proxy used to effect the download. For instance, where each of the plurality of storage areas corresponds to a different user, the downloaded data may be stored in the storage area corresponding to the user whose user information was contained in the proxy.

Next, as represented in block 1600, the Intermediary Server 400 transfers the downloaded data to a CV System 600. The operations represented in block 1600 may be accomplished in a number of ways. For example, at a date and time after which a download has occurred, the user, who originally requested the download using CR System 300 may operate a CV System 600 in communication with the Intermediary Server 400 to retrieve the downloaded data from Intermediary Server 400 to CV System 600 where the user may view the data. For instance, a user may operate the CV System 600 to interact with FS System 420 to view a list of files stored in the user's individual storage area and select the file the user wishes to retrieve. The selected file is then transferred from FS System 420 to CV System 600.

In another example, after a download has occurred, FS System 420 may send a communication, e.g., an e-mail, to the user that requested the download, e.g., using the user's e-mail address contained in the user information of the object corresponding to the download. The e-mail may contain a link to the downloaded file stored at FS System 420 so that the user, operating a CV System 600, may, by opening the e-mail and selecting the link, cause the file stored at FS System 420 to be automatically transferred to the CV System 600 operated by the user.

In either example, known access control procedures may be used to authenticate the user prior to allowing the user to retrieve the stored file. For instance, FS System 420 may require the user to provide a predefined user ID and password.

It should be noted that CV System 600 may be a distinct client device from CR System 300 or CV System 600 may be the same client device as CR System 300. For example, although the client device operated by a user may be capable of viewing content the user desires to download, e.g., where CR System 300 is a notebook computer, the First Network 200 through which client device communicates with Content Server 100 may be a low bandwidth network (e.g., a cellular network) or may be a network subject to delays at the time the user makes the download request (e.g., the Internet). Consequently, the user may operate the client device as a CR System 300 to generate a download request, as described above, to download the content to an Intermediary Server 400 coupled to the user's home access network, which is a low delay, high bandwidth network. Then after the download has occurred, the user may connect the client device to his or her home access network and operate it as a CV System 600 to retrieve the content from the Intermediary Server 400, as described above.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

1. A method for facilitating the transfer of data from at least one server to a client device, the method comprising:
providing parameters including at least the identity of the data to be downloaded and the identity of the at least one server to a previously identified computer from which the data can be transferred to the client device;
the previously identified computer using the parameters to cause the data to be transferred from the at least one server to the computer.

2. The method of claim 1, further comprising obtaining the parameters to be provided.

3. The method of claim 2, wherein obtaining the parameters to be provided comprises obtaining parameters including the identity of the computer from which the data can be transferred to the client device.

4. The method of claim 3, wherein obtaining parameters including the identity of the computer comprises obtaining the identity of the computer from a memory.

5. The method of claim 2, wherein obtaining the parameters to be provided comprises obtaining parameters including user information necessary to access the identified data on the at least one server.

6. The method of claim 2, wherein obtaining the parameters to be provided comprises:
capturing a request to the at least one server to download the identified data; and
extracting at least some of the parameters from the captured request.

7. The method of claim 1, further comprising transferring the data from the previously identified computer to the client device.

8. The method of claim 1, further comprising providing computer code along with the parameters to the previously identified computer; and
wherein the previously identified computer executes the provided computer code in using the parameters to cause the data to be transferred from the at least one server to the computer.

9. A method for facilitating the transferring of data from at least one server to a client device, the method comprising:
providing a proxy that facilitates the downloading of data from the at least one server; and
transmitting the proxy to a computer capable of using the proxy to download the data from the at least one server and then transferring the downloaded data to the client device.

10. The method of claim 9, further comprising obtaining parameters including at least the identity of the data, the identity of the at least one server, and the identity of the computer; and
wherein providing a proxy comprises creating a proxy using the obtained parameters.

11. The method of claim 10, wherein obtaining parameters comprises:
capturing a request to the at least one server to download the identified data; and
extracting at least some of the parameters from the captured request.

12. The method of claim 9, wherein providing a proxy comprises providing a proxy including computer code which, when executed, causes the data to be downloaded from the at least one server.

13. A method for facilitating the transferring of data from at least one server to a client device, the method comprising:
receiving a proxy containing parameters including at least an identification of the data to be downloaded and the identity of the at least one server;
using the proxy to download the identified data from the identified at least one server; and
transferring the downloaded data to the client device.

14. The method of claim 13, further comprising:
storing the received proxy;
wherein receiving proxy comprises receiving a proxy containing parameters including a time at which the identified data is to be downloaded from the identified at least one server; and
wherein using the proxy comprises using the stored proxy to download the identified data from the identified at least one server at the time indicated in the parameters of the proxy.

15. The method of claim 13, wherein receiving a proxy comprises receiving a proxy containing parameters including user information necessary to access the identified data on the identified at least one server; and
wherein using the proxy comprises using the user information contained in the proxy to download the identified data from the identified at least one server.

16. The method of claim 13, further comprising:
storing the downloaded data; and
wherein transferring the downloaded data comprises:
sending an electronic message to a user containing a link to the stored data; and
transmitting the stored data to a client device being operated by the user upon the link being accessed.

17. A system for facilitating the transfer of data from at least one server to a client device, the system comprising:
programming in a user device, which causes the user device, in response to user input, to provide parameters to a computer, the parameters including at least the identity of the data to be downloaded and the identity of the at least one server; and
the computer, in response to receiving the parameters from the user device, using the parameters to cause the identified data to be downloaded from the at least one server to the computer, and in response to a communication received from the client device, transferring the downloaded data to the client device.

18. The system of claim 17, further comprising a user device containing the programming.

19. A system for facilitating the transferring of data from at least one server to a client device, the system comprising:
means for providing a proxy that facilitates the downloading of data from the at least one server; and
means for transmitting the proxy to a computer capable of using the proxy to download the data from the at least one server and then transferring the downloaded data to the client device.

20. The system of claim 19, further comprising means for obtaining parameters including at least the identity of the data, the identity of the at least one server, and the identity of the computer; and
wherein the means for providing a proxy comprises means for providing a proxy using the obtained parameters.

21. The system of claim 20, wherein the means for obtaining parameters comprises:
means for capturing a request to the at least one server to download the identified data; and
means for extracting at least some of the parameters from the captured request.

22. The system of claim 19, wherein the means for providing a proxy comprises means for providing a proxy including computer code which, when executed, causes the data to be downloaded from the at least one server.

23. A system for facilitating the transferring of data from at least one server to a client device, the system comprising:
means for receiving a proxy containing parameters including at least an identification of the data to be downloaded and the identity of the at least one server;
means for using the proxy to download the identified data from the identified at least one server; and
means for transferring the downloaded data to the client device.

24. The system of claim 23, further comprising:
means for storing the received proxy;
wherein the means for receiving a proxy comprises means for receiving a proxy containing parameters including a time at which the identified data is to be downloaded from the identified at least one server; and
wherein the means for using the proxy comprises means for using the stored proxy to download the identified data from the identified at least one server at the time indicated in the parameters of the proxy.

25. The system of claim 23, wherein the means for receiving a proxy comprises means for receiving a proxy containing parameters including user information necessary to access the identified data on the identified at least one server; and
wherein the means for using the proxy comprises means for using the user information contained in the proxy to download the identified data from the identified at least one server.

26. A computer program product comprising a computer usable medium having computer readable code embodied therein, the computer readable code, when executed, causing a computer to implement a method for facilitating the transferring of data from at least one server to a client device, the method comprising:
providing a proxy that facilitates the downloading of data from the at least one server; and
transmitting the proxy to a computer capable of using the proxy to download the data from the at least one server and then transferring the downloaded data to the client device.

27. The computer program product of claim 26, wherein the implemented method further comprises obtaining parameters including at least the identity of the data, the identity of the at least one server, and the identity of the computer; and
wherein, in the implemented method, providing a proxy comprises providing a proxy using the obtained parameters.

28. The computer program product of claim 27, wherein, in the implemented method, obtaining parameters comprises:
capturing a request to the at least one server to download the identified data; and
extracting at least some of the parameters from the captured request.

29. The computer program product of claim 26, wherein, in the implemented method, providing a proxy comprises providing a proxy including computer code which, when executed, causes the data to be downloaded from the at least one server.

30. A computer program product comprising a computer usable medium having computer readable code embodied therein, the computer readable code, when executed, causing a computer to implement a method for facilitating the transferring of data from at least one server to a client device, the method comprising:
receiving a proxy containing parameters including at least an identification of the data to be downloaded and the identity of the at least one server;
using the proxy to download the identified data from the identified at least one server; and
transferring the downloaded data to the client device.

31. The computer program product of claim 30, wherein the implemented method further comprises:
storing the received proxy;
wherein, in the implemented method, receiving a proxy comprises receiving a proxy containing parameters including a time at which the identified data is to be downloaded from the identified at least one server; and
wherein, in the implemented method, using the proxy comprises using the stored proxy to download the identified data from the identified at least one server at the time indicated in the parameters of the proxy.

32. The computer program product of claim 30, wherein, in the implemented method, receiving a proxy comprises receiving a proxy containing parameters including user information necessary to access the identified data on the identified at least one server; and
wherein, in the implemented method, using the proxy comprises using the user information contained in the proxy to download the identified data from the identified at least one server.
